(19) United States
(12) Patent Application Publication
(10) Pub. No.: US 2024/0294055 A1
(43) Pub. Date: Sep. 5, 2024

(54) INTEGRATED ANTI SHUFFLE BUMPER

(71) Applicant: Magna Exteriors Inc., Aurora (CA)

(72) Inventors: Christopher J. Kuntze, Goodrich, MI (US); Riad Chaaya, Clarkston, MI (US); Keijo J. Huotari, Fenton, MI (US); Scott Varisto, St. Clair, MI (US); Trevor Geiger, Imlay City, MI (US); Dennis Wiedenbeck, Livonia, MI (US)

(73) Assignee: Magna Exteriors Inc., Aurora, ON (CA)

(21) Appl. No.: 18/574,950

(22) PCT Filed: Jun. 29, 2022
(86) PCT No.: PCT/US2022/035487

§ 371 Date: Dec. 28, 2023

Related U.S. Application Data
(60) Provisional application No. 63/216,317, filed on Jun. 29, 2021.

(51) Int. Cl. B60J 5/10; B60J 5/04

(52) U.S. Cl. CPC B60J 5/107; B60J 5/0413

(57) ABSTRACT

A vehicle closure panel including a molded inner panel for resting on a vehicle body mounted shuffle bumper. The molded inner panel has a molded in shuffle bumper interface providing a solid interference stop with a shuffle bumper when the vehicle closure panel is in a closed position.

### CROSS-REFERENCE TO RELATED APPLICATIONS

This application is a PCT International Application and claims benefit of U.S. Provisional Patent Application No. 63/216,317, filed Jun. 29, 2021. The disclosure of the above application is incorporated herein by reference.

### FIELD OF THE INVENTION

The present invention relates to a thermoplastic vehicle closure panel with integrated anti shuffle bumper.

### BACKGROUND OF THE INVENTION

Liftgates and other vehicle closure panels such as side doors, frunks, hoods, fuel doors, deck lids and the like sometimes have fit issues or a loose fit to the door opening. This can cause undesirable issue with vehicle closure panels such as: excess gap and flush variation, water leaks, buzzes, squeaks and rattles, interference to body, wear and tear, paint wear or chipping, corrosion, excessive closing efforts, latch not engaging with striker and the like. Such issues are undesirable in vehicle manufacture.

Therefore, it is desired to eliminate the issues noted above.

In the past independent Shuffle type bumpers are often added to a vehicle closure panel such as a liftgate to create touch points in the areas of concern, such as the lower outer corners of a liftgate, to control the fit, and eliminate the concerns noted above.

The shuffle bumpers are often a two-piece design with one piece mounted to the body door opening, and the interfacing piece mounted to the liftgate using fasteners, adhesives or other attachment methods. Thus, a two-piece shuffle bumper increases investment cost, piece price, assembly cost, build variation, appearance issues.

The shuffle bumpers will now be a design that has one piece mounted to the body door opening, and the interfacing piece molded to the liftgate. sections and views attached to show the design.

Shuffle bumper functional surface molded into the inner panel surface.

### SUMMARY OF THE INVENTION

A vehicle closure panel including a molded inner panel for resting on a vehicle body mounted shuffle bumper. The molded inner panel has a molded in shuffle bumper interface providing a solid interference stop with a shuffle bumper when the vehicle closure panel is in a closed position.

Integrating the shuffle bumper into the inner panel surface of the liftgate creates an efficient design that eliminates the issues noted above.

The shuffle bumpers will now be a design that has one piece mounted to the body door opening, and the interfacing piece molded to the liftgate sections and views attached to show the design.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a is a side view of the liftgate of the present invention;

FIG. 2 is a rear view of the inner panel with the shuffle bumper interface surface of the present invention;

FIG. 3 is a sectional view taken along line C-C of the present invention; and,

FIG. 4 is a detailed view of area A2 taken from FIG. 1.

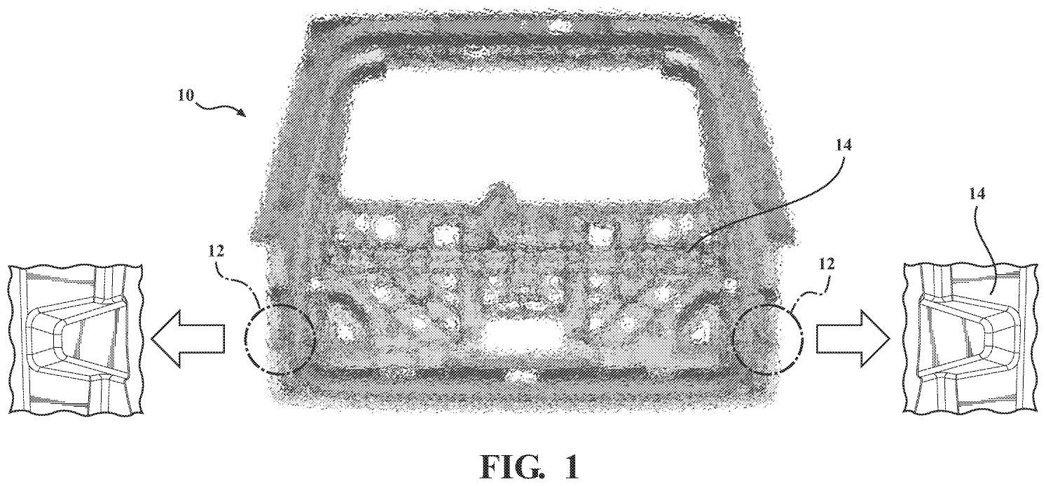

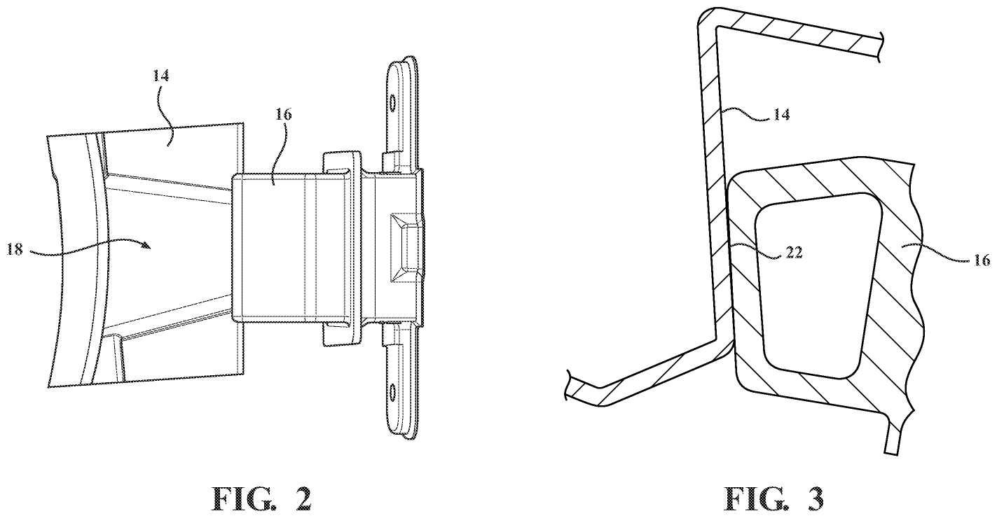

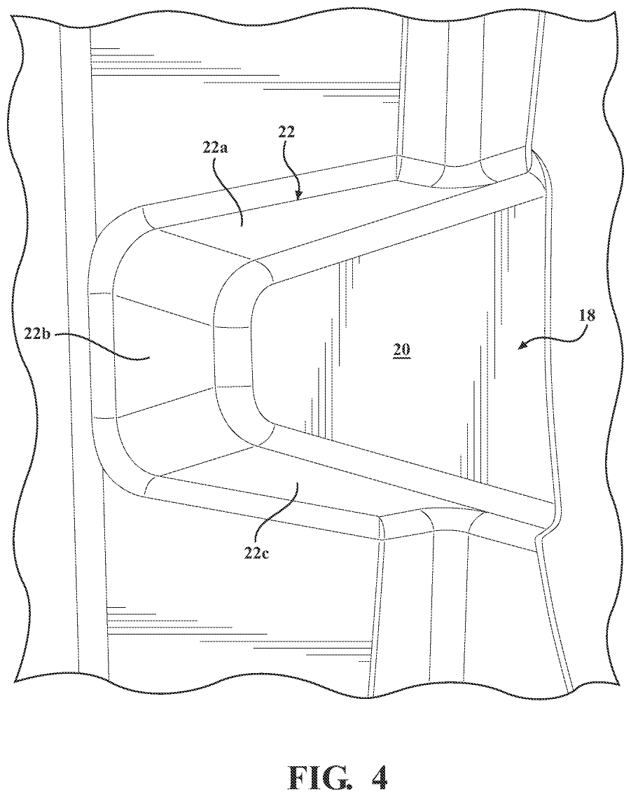

### DETAILED DESCRIPTION OF THE PREFERRED EMBODIMENTS

The following description of the preferred embodiment(s) is merely exemplary in nature and is in no way intended to limit the invention, its application, or uses.

In accordance with the present invention there is provided a closure panel of a vehicle such as rear liftgate generally shown at 10. The liftgate 10 includes at least a body bumper area 12 and a molded inner panel 14. The body bumper area 12 (A2) includes a body mounted shuffle bumper 16. Typically, the shuffle bumper 16 is of a rubber or elastomeric material and is attached to the body of a vehicle for providing a solid stop to a vehicle door. In this case there are two rear shuffle bumpers 16 on each side of the vehicle.

The molded inner panel 14 includes a molded in shuffle bumper interface generally indicated at 18 providing a solid interference stop with shuffle bumper(s) 16 when the liftgate is in a closed position. The shuffle bumper interface 18 includes a raised area 20 which contacts the shuffle bumper with an interference fit when the liftgate is closed. This surface 20 faces inward toward engagement with the shuffle bumper 18. The shuffle bumper interface includes surface 20 which is a central flattened interface attached to the inner panel 14 by at least one structural wall member generally indicated at 22 Preferably at least three walls support the flattened member and four walls 22a, 22b, 22c are shown for forming a triangular shaped flattened member 20.

Typically, the inner panel includes structural reinforcement members for providing hinge, lock and strut mountings and to provide structural rigidity to the liftgate as is known in the art. An outer panel is usually provided for providing the outer show surface part of the liftgate. While a liftgate application of this technology is shown other vehicle closure panels such as side doors, frunks, hoods, fuel doors, deck lids and the like can benefit from an integrally molded shuffle bumper interface in an inner panel.

Molding materials are typically long glass fiber filled thermoplastics such as thermoplastic olefins which are injection molded with the shuffle bumper integrally molded therein. Other molded materials such as SMC's and other thermoplastics or thermosets are also used for providing the integrally molded shuffle bumper in an inner panel.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A vehicle closure panel including a molded inner panel for resting on a vehicle body mounted shuffle bumper comprising;
said molded inner panel including a molded in shuffle bumper interface providing a solid interference stop with a shuffle bumper when the vehicle closure panel is in a closed position.

2. The vehicle closure panel of claim 1 wherein said shuffle bumper interface is a raised area facing inward for interference fit with a shuffle bumper of a vehicle.

3. The vehicle closure panel of claim 4 wherein the shuffle bumper interface includes a central flattened interface attached to the inner panel by at least one structural wall member.

4. The vehicle closure panel of claim 5 wherein there are at least two walls which extend to support the central flattened interface.

5. The vehicle closure panel of claim 1 wherein the panel is a liftgate, side door, frunk, hood, fuel door, or a deck lid.

6. The vehicle closure panel of claim 1 wherein the panel is an inside panel of a liftgate.

7. The vehicle closure panel of claim 1 wherein the panel is injection molded.

8. A vehicle closure panel including a molded inner panel for resting on a vehicle body mounted shuffle bumper comprising;
said molded inner panel including a an integrally injection molded in place shuffle bumper interface as a one piece molding with the inner panel providing a solid interference stop with a corresponding shuffle bumper of a vehicle when the vehicle closure panel is in a closed position.

9. The vehicle closure panel of claim 1 wherein said shuffle bumper interface is a raised area facing inward for interference fit with a shuffle bumper of a vehicle.

10. The vehicle closure panel of claim 4 wherein the shuffle bumper interface includes a central flattened interface attached to the inner panel by at least one structural wall member.

11. The vehicle closure panel of claim 5 wherein there are at least two walls which extend to support the central flattened interface.

12. The vehicle closure panel of claim 1 wherein the panel is a liftgate, side door, frunk, hood, fuel door, or a deck lid.

13. The vehicle closure panel of claim 1 wherein the panel is an inside panel of a liftgate.

14. The vehicle closure panel of claim 1 wherein the panel is injection molded.
